(19) United States
(12) Patent Application Publication
(10) Pub. No.: US 2025/0363995 A1
(43) Pub. Date: Nov. 27, 2025

(54) METHODS AND APPARATUSES FOR THE CONDENSATION OF SPOKEN TEXT

(71) Applicant: Applications Technology (AppTek), LLC, McLean, VA (US)

(72) Inventors: Evgeny Matusov, Aachen (DE); Adria Agusti Martinez Villaronga, Valencia (ES); Mudar Yaghi, McLean, VA (US)

(21) Appl. No.: 19/215,257

(22) Filed: May 21, 2025

Related U.S. Application Data
(60) Provisional application No. 63/650,056, filed on May 21, 2024.

(51) Int. Cl. G10L 17/18; G06F 40/58; G10L 17/02; G10L 17/04

(52) U.S. Cl. CPC G10L 17/18; G06F 40/58; G10L 17/02; G10L 17/04

(57) ABSTRACT

A speech condensation processing system and method includes an ASR system for a source language that receives an audio stream with speech and outputs at least one word sequence and time stamps in the language spoken, a memory that stores a condensation program and corresponding data and databases that store training data, which may include manually condensed data, two-way translated data, and aligned subtitle data, and a processor coupled to the ASR system and memory that executes the condensation program to format and condense text by transforming the at least one word sequence from ASR into human-readable text with proper casing and punctuation, and condenses the text based neural training to remove words from the at least one word sequence that are not relevant for meaning.

### CROSS REFERENCE TO RELATED APPLICATIONS

This application claims priority to U.S. Provisional Patent Application No. 63/650,056, filed on May 21, 2024, entitled “Condensation of Spoken Text: Methods and Apparatuses, the entirety of which is incorporated by reference herein. This patent application may also be related to U.S. patent application Ser. No. 16/741,477 and to U.S. Pat. No. 12,073,177.

### FIELD OF THE INVENTION

The present invention is generally directed to performing text condensation and formatting and more specifically is directed to systems and methods for inputting text as raw unformatted output from a speech recognition system or other source and processing it to create formatted output that may be a shortened version of that text, while the meaning of the text remains intact.

### BACKGROUND OF THE INVENTION

Several hundreds of hours of new video content are produced every day, from movies and tv series to unscripted live content such as news broadcast shows, sports broadcasts, etc. In an effort to widen the potential audience, including reaching those with hearing impairments, content providers try to accompany these broadcasts with subtitles, relying on (partially) automated solutions to that goal.

Automatic speech recognition (ASR) systems are usually trained using uncapitalized and non-punctuated text, and so is the output they produce, which is harder to read and not acceptable for a TV station. In addition, especially in live unscripted contents, speakers can talk faster than the audience can read the subtitles, and often introduce hesitations, filler words, and other meaningless or not very important formulas in their speech.

There is a need for a system that is capable of formatting the output of an ASR system and removing words and phrases with low information content, and even automatically perform some rephrasing to ensure the length of each segment is appropriate for a comfortable reading speed while retaining most of the information content.

### SUMMARY OF THE INVENTION

According to an embodiment of the invention, a method for text condensation leverages an encoder-decoder neural network architecture to convert raw transcripts (e.g., from automatic speech recognition), potentially having speech recognition errors, but also hesitations, filler words, and not very fluent sentences, into a properly formatted written text. The output text conveys the same important information as the input transcript, but is formulated in a shorter way, so that the text can be read as subtitles with an appropriate reading speed despite a possibly fast speech rate. The text produced by the neural network removes less important information and filler words. To train the neural network, human-edited transcripts are leveraged, but also novel ways of using synthetic data may be implemented via two-way machine translation to a different language with a shortening mechanism. Other examples may include using other types of synthetic data, extended context, and lists of named entities, which must remain in the output as is, without any modifications. We also propose a single model that not only does text condensation, but also inverse text normalization (converting spoken numbers, dates, etc. to their written form with digits). In some embodiments, a controllable rate of text condensation may be implemented that can be adjusted based on the speaking rate of the speaker whose speech is being transcribed and has to be condensed.

According to an embodiment of the invention, a speech condensation processing system includes an ASR System, a memory, at least one database and a processor coupled to the foregoing. The ASR system for a source language receives an audio stream with speech and outputs at least one word sequence and time stamps in the language spoken. The memory stores a condensation program and corresponding data and the databases store training data, which may include manually condensed data, two-way translated data, and aligned subtitle data. The processor executes the condensation program to format and condense text by transforming the at least one word sequence from ASR into human-readable text with proper casing and punctuation, transforming words with numbers, dates, and/or monetary amounts into written form based on neural inverse text normalization, and condensing text based on to remove words from the at least one word sequence that are not relevant for meaning. According to some embodiments, the processor condenses by removing hesitations and filler words. According to still other embodiments, the system further includes a speaker diarization system that identifies a speaker and/or a subtitle segmentation system that receives condensed, formatted text and outputs compressed, segmented subtitles.

The condensation program may comprise an encoder that includes N networks of multi-head, self-attention and feed-forward layers, a decoder coupled to the encoder and a soft max layer coupled to the decoder, wherein during training the processor (i) couples the training data from at least one training database to the decoder, encoder and softmax layers and (ii) executes the condensation program instructions to train the network and update weights associated with the network based on loss between condensed target word sequences from the training database (manually or synthetically created) and the word sequences output by the decoder. The condensation program may be trained on human-corrected and edited ASR output so that the claimed text condensation system can correct and/or omit automatic speech recognition errors. It may also be constrained by an explicit length control that influences the number of produced characters per unit of time corresponding to the original speaker utterance, with an explicit control parameter value that can be adjusted by a user of the system. In other embodiments, the desired length control value may be updated automatically based on the speaking rate at a given time point.

According to another embodiment of the invention, a method of condensing speech includes: receiving a stream of speech at an ASR system; generating at the ASR system output of at least one word sequence of text and time stamps based on the speech; storing the outputted text, time stamps and text related in meaning to the outputted text but including corrected text and text with different levels of verbosity as training data; executing an application program to process the training data and train the condensation and transformation application and related models on the outputted text and text related in meaning; and finalizing and storing an operationally ready trained condensation and transformation application and related models.

### BRIEF DESCRIPTION OF THE FIGURES

The above described features and advantages of embodiments of the present invention will be further understood with reference to the below described figures.

FIG. 1 depicts a functional block diagram for training a transformer according to an embodiment of the present invention to compress and/or format text from a ASR system.

FIG. 2 depicts an illustrative block diagram of an overall architecture from an ASR system through a subtitle segmentation system incorporating a condensation/ITN system according to an embodiment of the present invention.

FIG. 3 depicts an illustrative block diagram of an implementation of a system according to an embodiment of the present invention.

FIG. 4 depicts a method according to an embodiment of the present invention.

### DETAILED DESCRIPTION

According to an embodiment of the present invention, a system and method for condensing and formatting the output of an ASR system is provided. The system and method may be implemented using neural networks, machine learning, and artificial intelligence and may be trained and then implemented according to the description herein. The system and method provide flexibility to condense the length of text while preserving its meaning in order to make the condensed text more easily consumed by those watching a video or a scene to which the text corresponds. For example, systems and methods according to an embodiment of the present invention may be advantageously used in a subtitling application where a version of the text is available from an ASR system, but the text has too many characters or words given the speed of the scene or video, the speed of the reader or average reader, or other considerations.

The output produced by a typical ASR system needs to be transformed before it can be used as subtitles. Traditionally, the data used in ASR systems is preprocessed to remove all capitalization, remove punctuation marks, and convert all non-text symbols (numbers, dates . . . ) to a text only format readable by the system in a process called text normalization (TN). The output of the system then undergoes a process called inverse text normalization (ITN), which tries to properly capitalize the text and add punctuation marks and formatting in order to turn the output into a more human-readable format including expressions like dates, mathematic operations, etc.

In addition, there are some scenarios where the length of text segments (in characters) is too long with regards to its duration (in seconds) in a corresponding scene or video, exceeding the threshold of what people can read comfortably. Therefore, a text condensation process may be applied.

A neural machine translation (NMT) model (a sequence-to-sequence system with an encoder-decoder architecture) according to an embodiment of the invention may be able to achieve a high success in ITN implementations to perform text condensation.

To train such NMT models for text condensation, the following types of data may be used, for example:
Manually annotated data: Human generated data from news broadcasts where a professional subtitler has generated formatted and length-appropriate subtitles by editing down the original ASR output.
Synthetic data via two-way translation: To increase the amount of data available, synthetic data may be created by automatically translating English written text sentences into a pivot language, and then back into English. NMT systems may have length control features that are capable of generating longer and shorter translations. In one case, longer translations generated from the pivot language into English, yield equivalent longer sentences. Then these long sentences undergo the TN process to match the expected input. The original English written text sentences form the “target translation”, i.e., are used as ground truth during training of the proposed text condensation system.
Synthetic data via automatic alignment of different subtitle files: for some prior content, subtitle files with different levels of verbosity exist (e.g., subtitle files for deaf and hard-of-hearing audiences, more verbatim captions, or manually condensed subtitles which form a template for subsequent translation into other languages). Subtitle versions of different verbosity may be automatically aligned. The alignment can be performed using established sentence alignment methods in statistical and neural MT. Then, the more verbose version of the same content (film or news broadcast, for example), forms the input sentence for training the neural text condensation model, whereas the shorter, less verbose version is then used as the ground truth during training.

Other types of data may also be used and the foregoing list is not meant to be exhaustive. Furthermore, the above training data may be combined with the training data of the baseline ITN system which may be comprised of a verbatim transcript of a spoken utterance on the source side (no casing, punctuation, numbers, dates, etc., written as words) and the same sentence in its written, but uncompressed form on the target side (with casing, punctuation, and digits). To make this training data compatible with the condensation training data described above, text normalization (TN) may be applied to get a spoken/verbatim form of the uncompressed source sentence (if it is not already in this form as coming from the ASR output) but keep the condensed target sentence in its written form.

The core sequence-to-sequence joined conversation/ITN system may be trained using a Transformer architecture, such as a Transformer architecture that is state of the art in neural MT (Vaswani et al., 2017). The Transformer may be an Encoder-Decoder neural network architecture using multi-head self-attention, which allows the model to attend different parts of the input sentence, rather than using a fixed-length context window, allowing the model to better capture long-range dependencies in the input and output sequences. It also may introduce other features allowing this architecture not only to achieve better quality, but also improved parallelizability and general performance of the models with regards to previous architectures.

During the training process of a neural machine translation model, optimization may be done by iteratively updating the model parameters using an optimization algorithm (such as SGD or Adam, or other optimization algorithms). In general, the optimizer computes a gradient of the loss with respect to the parameters, and updates parameters based on that gradient. Instead of doing that for single training samples, it is usually done in batches, whose size can be tuned to achieve a balance between the speed of convergence and memory requirements.

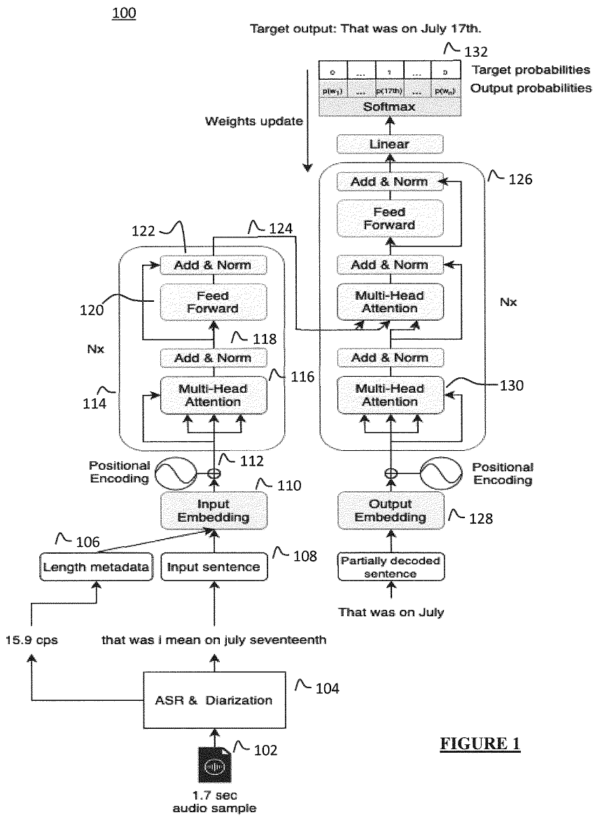

FIG. 1 depicts a functional block diagram of a transformer architecture 100 that shows an implementation of a training process for a sample sentence. Referring to FIG. 1, the Transformer architecture is used for text condensation. ASR & Diarization 104 is the automatic speech recognition and speaker identification module, many of which are well known. It produces, for example, segments of automatically transcribed texts with speaker information and start and end time information for each word and segment. The ASR and Diarization 104 may be coupled to a speech signal stream, and receives and processes speech stream segments 102 from the speech signal stream.

Based on the start and end time information, the ASR & Diarization 104 determines and outputs length metadata 106, which may include a reading speed, i.e., the number of words/characters in a sentence divided by the sentence length in seconds or produce characters or words per second, or similar data, used to determine a degree of text condensation required. The words of the input sentence 108 are determined and output by the ASR 104 and the length metadata may be converted by a condensation and ITN system 110, according to an embodiment of the present invention, to a sequence of input embeddings, extended with positional information 112 as in the standard Transformer architecture. These embeddings 112 may then be fed into an encoder 114, which includes N networks of multi-head self-attention 116, add and normalize 118 and feed-forward 120 layers that may process the input embeddings along with positional information.

The decoder 126 produces as output a condensed sentence, while attending to the representations in the encoder (cross-attention) which are fed to a multi-head attention layer 128 and to the embeddings of the words 130 already generated in the previous steps (output embeddings). The most probable next word is determined with a softmax 132 operation from the logits of the last layer of the decoder 126. When training the network, the weights may be updated via back-propagation based on loss between the representations of the target condensed sentence (target output) and the sentence produced by the decoder.

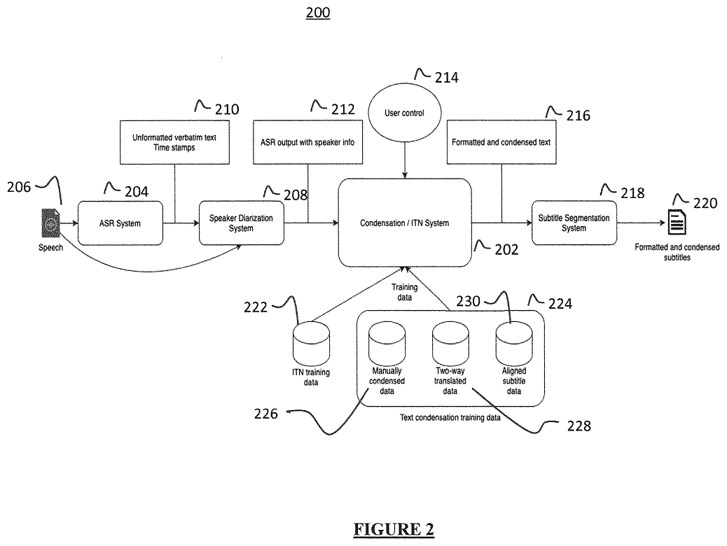

FIG. 2 depicts a block diagram 200 of an overall architecture of the proposed invention. Referring to FIG. 2, the neural text condensation and ITN system 202 may be trained using parallel data of three types, as described in detail in this invention, as well as data for the inverse text normalization task. An ASR system 204 may receive a speech signal 106 and output recognized text and related data 210, such as time stamps, to a speaker diarization system 208, which may also receive the speech signal directly. The ASR and Speech diarization systems may in turn output their data 212, including ASR output and speaker information, to the trained Condensation/ITN system 202. The Condensation System 202 receives the ASR and diarization output and based on its training, as described herein, may output formatted and condensed text 216 directly or to a subtitle segmentation system 218.

The condensation system 202 may also be coupled to a user interface 214, such as a mobile phone or computer equipped with a browser, that is coupled with the condensation system 202 by a network connection, such as a wireless, optical or electronic network or local or wide area networks, including the Internet. The user interface may allow the user to interact with the condensation system and allow the user to control aspects of the performance of the condensation system, such as the degree of condensation.

The condensation system 202 may further be coupled with various databases, for example an ITN training database 222 and text condensation training data databases 224, including manually condensed data 226, two-way translated data 228, and/or aligned subtitle data 230. The neural text condensation system 202 may use the training data in a training mode to allow training and optimization under user control 214. Alternatively, the neural text condensation system may be deployed to take input audio streams, for example, from a video with synchronized video and audio, and generate condensed text output 220 that are embodied as subtitles associated with video frames.

When deployed to process audio that is part of a video, at inference/deployment time, the automatic transcript, generated with ASR, is enhanced with speaker information and word time information for each word and sentence and is fed into the neural condensation/ITN system (FIG. 1). The output is the formatted and condensed text, which may potentially be further processed by a subtitle segmentation system that generates properly segmented subtitles for display to a user on a TV or computer screen.

Length control features may also be implemented to extend the model, to have finer control of the desired output length. The following illustrative and non-limiting examples of length control methods may be used as part of processes to enable length control:
Specification of a length pseudo-token (“extra short”, “short”, “medium”, “long”). In training of the system, the pseudo-token for a particular sentence pair is determined by computing the length ratio between the source and the target sentence. Thus, when specifying “short” or “extra short”, the target sentence is significantly shorter than the source sentence, and the neural system learns to produce such shorter sentences.
Use of length-difference positional encoding (LDPE) from Takase and Okazaki (2019). It replaces the positional encoding in the transformer decoder, which usually encodes the absolute target position, with a version that “counts down” from a desired output length to zero. At each decoding step the available remaining length is an input to the decoder and thus the model learns to stop at the right position. In training, the desired length is usually set to the reference target length, while at inference time it can be set by the user.
A rescoring approach, whereby the neural text condensation system produces multiple condensation candidates per given sentence, and the one that fits the desired user length the most is selected. The approach can be extended with on-the-fly sentence embedding computation for the original sentence and the condensed sentence, so that the condensed sentence that is closest to the original sentence in the embedding space (and thus a significant loss of important information is avoided), but still sufficiently shortens it.

The three approaches described above have been tested experimentally in a cross-lingual setting of real machine translation with length control between different human languages, see (Wilken and Matusov, 2022). Here by contrast, according to an embodiment of the invention, the approaches may be implemented differently in the same language for a different task—a text compression task—and with a parameter of a desired length value that can be varied to adjust the length of each condensed sentence to the desired reading speed.

To this end, given the ASR output with word timestamps (start time and duration of each word in milliseconds), and the length of the ASR output in characters, an embodiment according to the present invention can compute reading speed for the original recognized sentence, and then also compute the goal text length in characters to match the desired reading speed, given the duration of the utterance. According to another embodiment, a decision about the desired length is re-visited after each recognized utterance, but especially at times when speaker change is detected.

In one illustrative embodiment of the invention, a neural architecture may be employed for the text compression system that uses extended context, for example, the context of preceding sentences. This allows the system to do more or less compression, depending on whether or not a certain entity is already mentioned in the preceding sentence and thus can be omitted or automatically replaced with a pronoun.

According to another embodiment, use of a list of important terms/words that should not be dropped or altered during text compression may be incorporated into systems and methods. These can be provided by a user via a user control interface 214 and can include a file containing named entities, but also important words such as “deny, agree, fulfill”, etc., which are very much relevant for the correct understanding of an utterance. This list can be provided to the system by the user for customization of system's condensation capabilities. Technically, each word in the input sentence that matches an entry in the list would be assigned a special factor (neural embedding) that marks that this word is important. In training, those words can be automatically marked as important which are consistently present both in the original source sentence and its condensed target version.

Finally, the system may be partially trained on corrected and condensed ASR output. The system may learn to correct recognition errors, or ignore them in case they happen in a part of the sentence that is removed for condensation. This can further improve the user experience in the case of a fully automatic scenario where the output of the text condensation system is directly presented to the user in the form of captions or subtitles. It would also improve the efficiency of human post-editing for human-in-the-loop scenarios.

These are some examples of how an embodiment of the system is capable of condensing and formatting some sentences:
Input: absolutely i think
Output: Absolutely.
Input: i think it depends on your time horizon so as you say
Output: I think it depends on your time horizon.
Input: property shares in particular
Output: Property shares.
Input: since that twitter deal was announced this chart on the bloomberg just showing how really yields have surged since then so how likely is it that this deal will get done in leverage finance
Output: Since that Twitter deal was announced, this chart showing how yields have surged since then, how likely is it that this deal will get done in leverage?
Input: terminal subscribers can get that debut go it's also available on the mobile in the bloomberg
Output: Terminal subscribers can get that debut go.
Input: i've seen the bloomberg i've seen the bloomberg
Output: i've seen the Bloomberg.
Input: revenue because there are about thirty percentage of the coffin you'll
Output: There are 30 percentage of the coffin.

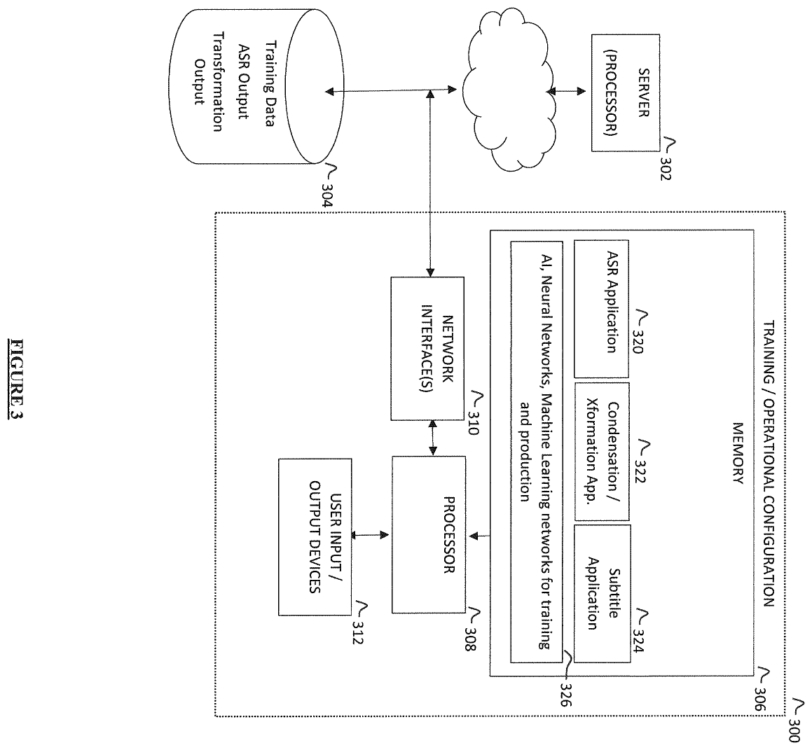

FIG. 3 depicts an illustrative block diagram of an implementation of a training system according to an embodiment of the present invention. Referring to FIG. 3, a training system 300 is coupled to a server 302 with a training database 304, and incorporates a memory 306 that stores programs, parameters and networks, a processor 308, a network interface 310 and user input/output devices 312 such as a keyboard, mouse, display, microphone and speakers. The server 302 enables the training system to access video and other content via the Internet, a local area or wide area network or other cloud or network-based system. The database may include training data such as examples or ASR output for content, corrected ASR output, full length and abbreviated text output corresponding to content, and transformation output, among other types of data. The training configuration system may include a general purpose or special purpose computer that includes a processor such as a microprocessor, GPU, multiple GPU processor designed specifically for video processing or machine learning/AI training. The processor 308 may be coupled to one or more network interfaces 310, one or more user input/output devices 312 and memory 306. The network interface 310 enables the processor to access content for training via a network.

The user interface enables a user to interact with the training configuration system in order to supervise the training process, change parameters and implement a completed condensation/transformation app to verify performance or implement a production version. The memory 306 may store data, program instructions and neural network, language and other models, modules and other architectures that are trained according to one or more embodiments of the present invention. The memory may store, for example, application program instructions that when executed by the processor cause the training configuration system to perform the functions described in the functional blocks and modules shown and described herein and according to the methods described herein. The memory may store parameters, such as reading speed, length of textual output, verbosity, and subtitle parameters among other things. The memory may also store additional constraints, training application programs, ASR application programs 329, Condensation/transformation programs 322, subtitle application programs 326, and various AI, neural networks, and/or machine learning architectures and/or models and programs 326 that may be trained or used in training as described herein.

Once trained, the condensation/transformation application 322 may be applied to ASR output to automatically generate condensed and formatted text corresponding to content and/or subtitles.

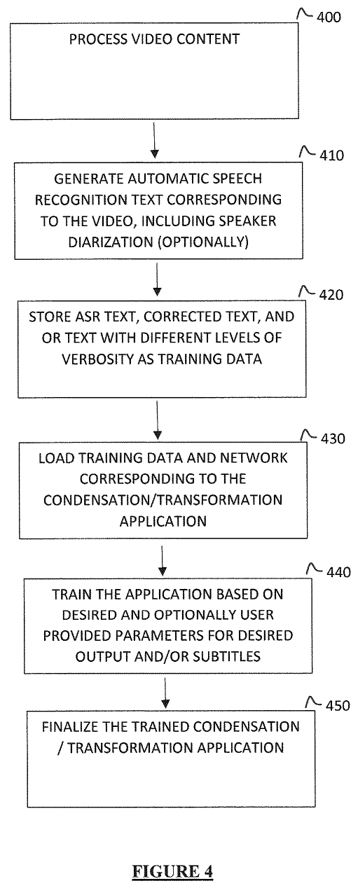

FIG. 4 depicts a method according to an embodiment of the present invention. Referring to FIG. 4, the method includes processing video content 400 that includes audio content and audio associated with frames of the video content. An ASR system in 410 generates text corresponding to the video or other content including optional speaker diarization and time stamps. In 420, the text may be stored in a database and made available for training. The text output stored may be directly generated or may have been previously generated. The text output may also include corrected versions of the text and may have multiple versions of text for the same video with different levels of verbosity.

The training data may be made available to the training systems shown and described herein in 430, by providing the application program or models access to the training data in one of the databases and/or loading the data into memory for processing by the application, models and processor. The user in 440 may also select parameters to be applied during training and may select the architecture for the condensation/translation application and constituent models. The user may train the application and any subtitling by configuring the system, selecting training data, parameters and constraints and generating condensed and formatted output from intput ASR. In 450, the trained system may be finalized and implemented to automatically generate condensed, formatted text and/or subtitles from video content and/or ASR data associated with video content used as input to an embodiment of the condensation system described herein.

The proposed method may be effectively combined with a subtitle segmentation algorithm described in U.S. patent application Ser. No. 16/741,477 by AppTek's Patrick Wilken and Evgeny Matusov, whereby condensed sentences would be put into subtitles of proper length, number of lines, number of characters per line, and confirming to the desired reading speed as given by the established subtitling guidelines.

US patent publication no. US20070299664A1 describes an automatic text correction system. That patent publication describes automatically extracting human-altered text segments based on the edit distance (Levenshtein) alignment and aggregates them as re-write rules. This means that these rules can only perform corrections locally. According to embodiments of the present invention, there is no such limitation. Whole sentences can be completely re-written using words which are not part of the input, and the output sentence may have a completely different sentence structure with a different word order, while the same meaning is kept. Also, while rules extracted with the method of US20070299664A1 may include shortening and removal of hesitations, as described there for a medical dictation scenario, they are not intended for text condensation and can also capture other phenomena (e.g., the reverse—expansion of acronyms). Also, that work is not in any way a prerequisite for or related to embodiments of the present invention.

Unlike parsing a given sentence and identifying those parts of a syntactic parse tree which carry little information and can be removed, according to some criteria usually defined by rules, according to an embodiment of the present invention, no explicit rules are required, and parsing may not be used because of input conditions. Input may be spontaneous speech and its automatic transcriptions which often have recognition errors. All of this makes parsing very difficult and error prone. According to an embodiment of the present invention, parsing may not be used—and instead a neural network is trained to implicitly learn to identify sentence parts which are removed while keeping fluency of the resulting condensed sentence due to the neural MT system's and method's effective use of context and language modeling capabilities.

The functional block diagrams shown and described above may be implemented on computer servers, systems on a chip, microprocessors, processors, GPUs and other general or special purpose elements. The GPU or processor may be coupled to memory, databases and other systems described herein including ASR systems, subtitle systems, subtitle segmentation systems, networks and other servers. The functional blocks may be implemented as neural networks, data and/or code in the memory that is coupled to the processor and that includes program instructions that when executed cause the GPU, server, processor or other general or special purposes processor or element to perform the tasks shown and described herein. While particular embodiments have been shown and described herein, it will be understood by those having ordinary skill in the art that changes may be made to those embodiments without departing from the spirit and scope of the invention.

What is claimed is:

1. A speech processing system, comprising:
a) an ASR system for a source language that receives an audio stream and outputs at least one word sequence of text and time stamps in the language spoken;
b) a memory that stores a condensation program and corresponding data;
c) at least one database that stores training data;
d) a processor coupled to the memory and databases that executes the condensation program to: format and condense the text by transforming the at least one word sequence from the ASR system into human-readable text with proper casing and punctuation, transforming words with numbers, dates, and monetary amounts, into written numerical form based on neural inverse text normalization; and to condense the at least one word sequence to remove words from the at least one word sequence that are not relevant for meaning.

2. The system according to claim 1, wherein processor condenses by removing hesitations and filler words.

3. The system according to claim 1, further comprising a speaker diarization system coupled to the ASR system, wherein the processor identifies a speaker for at least one of the at least one word sequence.

4. The system according to claim 3, further comprising a subtitle segmentation system, coupled to the processor, that is configured to receive the condensed and formatted text from the processor and output compressed, segmented subtitles.

5. The system according to claim 1, wherein the training databases include manually condensed data, two-way translated data, and aligned subtitle data based on length metadata.

6. The system according to claim 5, wherein the condensation program comprises an encoder that includes N networks of multi-head self-attention and feed-forward layers, a decoder coupled to the encoder and a soft max layer coupled to the decoder, wherein during training the processor couples the training data from the training database to the decoder, encoder and softmax layers and executes the condensation program instructions to train the network and update weights associated with the network based on loss between condensed target word sequences from the training database (manually or synthetically created) and the word sequences output by the decoder.

7. The system according to claim 6, wherein the program is trained on human-corrected and edited ASR output so that the claimed text condensation system can correct and/or omit automatic speech recognition errors.

8. The system according to claim 7, wherein the program is constrained by an explicit length control that influences the number of produced characters per unit of time corresponding to the original speaker utterance, with an explicit control parameter value that can be adjusted by a user of the system.

9. The system according to claim 8, further comprising updater program instructions residing in memory that when executed by the processor automatically updates the desired length control value (e.g., the desired number of characters in system's output given the number of characters in the input) based on the speaking rate at a given time point.

10. The system according to claim 9, wherein the user specifies which entities (words and phrases) should not be edited away.

11. The system according to claim 10, wherein training data is created by a method, comprising:
e) taking a concise written sentence and translating it to a foreign language and back to the original language with an MT system that allows the user to request a longer than usual translation; and
f) using the resulting longer sentence as an input sentence during training, and the concise written sentence is used as the desired output (target) sentence.

12. The system according to claim 10, wherein training data is created by a method, comprising: automatically aligning sentences from multiple versions of human-generated subtitles of the same speech signal, so that the more verbatim, longer sentence in an aligned sentence pair is used as the source sentence, and the shorter, condensed sentence is used as target sentence.

13. The system according to claim 8, wherein the length-control and length-awareness constraints are based on any of the following methods:
g) positional encoding of the remaining length
h) pseudo-tokens on the source or target side which encode the desired length with several discrete values (e.g., “short”, “long”)
i) an N-best list from the system with condensation candidates of different length for the same input sentence, from which a candidate can be selected that has the desired length (number of characters) and at the same time is semantically near or equivalent to the input sentence.

14. The system according to claim 3, wherein the speaker diarization is used to detect points in time when a speaker change happens and thus an adjustment of the level of text condensation may be triggered that may be necessary because of a different speaking rate of the new speaker.

15. The system according to claim 1, wherein a dialog aware MT system is configured to translate considering a context of a previous sentences for a more context-aware text condensation, so that information already mentioned in a previous one or more sentences is more likely to be edited away in a current word sequence output.

16. The system according to claim 1, further comprising functional components that are executed in remotely accessible networks or a cloud implementation that are coupled to the processor via computer networks and computer network interfaces, such as wired, optical or wireless networks, transceivers or interfaces to enable training the condensing program or processing word sequences.

17. A method of condensing speech, comprising:
receiving a stream of speech at an ASR system;
generating at the ASR system output of at least one word sequence of text and time stamps based on the speech;
storing the outputted text, time stamps and text related in meaning to the outputted text but including corrected text and text with different levels of verbosity as training data;
executing an application program to process the training data and train the condensation and transformation application and related models on the outputted text and text related in meaning; and
finalizing and storing an operationally ready, trained condensation and transformation application and related models.

18. The method according to 17, further comprising:
receiving training parameters from a user computer; and
executing the application program to further alter the training of the condensation and transformation application and related models based on the training parameters provided by the user.

19. The method according to 17, wherein the condensation and transformation program includes N networks of multi-head, self-attention and feed-forward layers, within an encoder and a decoder, and a softmax layer coupled to the decoder, and wherein executing the application program to process and train includes updating weights associated with the N networks based on loss between condensed word sequences and from the training database and word sequences output by the decoder.

20. The method according to claim 19, wherein the training data includes manually condensed data, two-way translated data, and aligned subtitle data.
